(19) United States
(12) Patent Application Publication
(10) Pub. No.: US 2014/0279400 A1
(43) Pub. Date: Sep. 18, 2014

(54) COMPUTER IMPLEMENTED METHOD FOR DETERMINING LIENHOLDER IDENTITY AND MAKING A SHORT SALE OFFER

(71) Applicant: Auction.com, LLC, Irvine, CA (US)

(72) Inventor: Jason Allnutt, Irvine, CA (US)

(73) Assignee: Auction.com, LLC, Irvine, CA (US)

(21) Appl. No.: 14/213,836

(22) Filed: Mar. 14, 2014

Related U.S. Application Data
(60) Provisional application No. 61/852,088, filed on Mar. 15, 2013.

(51) Int. Cl. G06Q 40/02; G06Q 50/16

(52) U.S. Cl. CPC G06Q 40/025; G06Q 50/16
USPC 705/38

(57) ABSTRACT

A system and method for identifying a lienholder and making a short sale offer. Examples include a user interface, in which prospective buyers may submit queries to browse listed properties and submit bids and a lienholder determination component configured to ascertain property and lien information. Further examples can include an offer submission interface through which short sale offers may ultimately be submitted.

### RELATED APPLICATION

This application claims the benefit of priority to Provisional U.S. Patent Application No. 61/852,088, filed Mar. 15, 2013, entitled COMPUTER IMPLEMENTED METHOD FOR DETERMINING LIENHOLDER IDENTITY AND MAKING A SHORT SALE OFFER; the aforementioned priority application being hereby incorporated by reference in its entirety.

### TECHNICAL FIELD

Examples described herein pertain generally to a system and method for determining a lienholder identity for an interested property and making a short sale offer through use of computing devices.

### BACKGROUND

Short sale transactions provide an efficient way for real property owners to sell their property even though they may owe more than its market value. As opposed to a foreclosure, a short sale transaction involves an offer and acceptance process between a buyer and owner, and an additional acceptance of the deal by a bank (or other lending institution) that currently holds a note on the property. In some instances, short sale opportunities are not often identifiable to the public at large.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1A illustrates an example system for determining lienholder identity and making a short sale offer;

FIG. 1B illustrates an example system for triggering an auction wherein a short sale offer is made through a short sale interface;

FIG. 1C illustrates a similar example system for triggering an auction in the event of a short sale offer and generating a bid report;

FIG. 2 illustrates an example method of triggering an auction and generating a bid report;

FIG. 3 is a block diagram that illustrates a computer system upon which examples described herein may be implemented;

FIG. 4 illustrates an example system for managing the creation and workflow of a short sale process via an online platform;

FIG. 5 illustrates an example method for generating a short sale package for a seller for submission to a bank; and

FIG. 6 illustrates an example method for managing workflow of a short sale, including interfacing with a seller, bank and prospective buyer.

### DETAILED DESCRIPTION

Examples described herein provide a system and computer-implemented method for generating short sale opportunities relating to real property assets. The system automates listing generation and short sale authorization from an interested lender.

According to an example, a computer-implemented method for creating a short sale for a real property asset is provided. The method includes providing a seller interface for network communication with a seller and prompting the seller for information associated with the real property asset. The information includes media content relating to different points-of-interest of the asset. The information associated with the asset is aggregated to generate a short sale listing. The seller is also prompted for financial hardship information, and market information regarding the real property asset. The financial hardship information and the market information are assembled into a short sale package for submission to a lending institution that holds a note on the real property asset.

Systems and methods disclosed herein include a property listing database to store lien information corresponding to one or more items of property listed on an auction forum, a lienholder database to store lienholder accounts including contact information for lienholders corresponding to the one or more items of property, and one or more servers and or processors to implement methods corresponding to managing short sale transactions. Specifically, the one or more processors can initially monitor the auction forum which includes one or more auctions for the items of property. The processors can be configured to detect a short sale offer for a selected property listed on the auction forum, and, in response to detecting the short sale offer, the one or more processors can acquire lien information from the property listing database for the selected property. This lien information can include an account identifier for a lienholder account associated with a lienholder of the selected property. Furthermore, the one or more processors can then accessing the lienholder account in the lienholder database to determine contact information for the lienholder of the selected property, and, based on the contact information, the one or more processors can submit the short sale offer to the lienholder of the selected property.

Furthermore, the processors can be configured to determine, from the short sale offer, a property identifier for the selected property. Such an identifier can be used to correlate the selected property with the lien information in the property listing database. Further still, the contact information can be determined from the lienholder account by sending a query to the lienholder database. In response, the lienholder database can perform a search, and access the lienholder account itself, before sending contact information to the system. In such variations, the lienholder database may be a standalone server configured to process requests and perform searches based on those requests.

Alternatively, the system can be configured to dynamically manage the property listing database and the lienholder database to reflect current lienholder and account information for any of the items of property listed or not listed on the auction forum. In such variations, the lienholder accounts stored in the lienholder database, and data stored in the property listing database may be accessed and modified dynamically. Alternatively, the property listing database and the lienholder database may be managed on a single storage device.

The system can be configured to generate and provide an auction forum interface integrated in a user network for the auction forum. The forum interface can enable users to browse property listings and submit bids for any of the items of property. In such variations, any number of short sale offers can be submitted over the auction forum interface and ultimately end up in front of a lienholder.

The lienholder account can be unique to the auction forum. As such, each lienholder can have a specific account showing all properties to which a respective lienholder is associated. Thus, after determining the short sale offer is automatically submitted to the lienholder of the selected property via the auction forum interface or a separate offer submission interface associated with the auction forum. Such an offer submission interface can be specific to short sale offers.

As used herein, an “asset” may refer to an interest in real property, such as residential or commercial real estate. Also as used herein, a “user” may refer to an individual operating a computing device. An example of a user may include an owner of a real property asset, an asset evaluator, a home inspector, an appraiser, etc.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component may include a program, a sub-routine, a portion of a program, or a software component or a hardware component capable of performing one or more stated tasks or functions. As used herein, a module or component may exist on a hardware component independently of other modules or components. Alternatively, a module or component may be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium that is non-transitory in nature. Machines shown or described with figures below provide examples of processing resources and non-transitory computer-readable mediums on which instructions for implementing examples of the invention can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on non-transitory computer-readable mediums. Additionally, examples may be implemented in the form of computer-programs, or a computer usable carrier medium capable of carrying such a program.

When a property owner cannot afford to repay the full amount of liens against his home, a typical practice involves a short sale, where a prospective buyer submits an offer amounting to less than the full amount of the liens, and the lienholder (e.g., a bank) agrees to release the liens on the property for the lower amount. However, typically for short sale items, lienholder approval is required before a final transaction takes place. Examples described herein relate to a triggering mechanism, wherein a short sale offer may trigger an automatic auction for a short sale item. The short sale item may then be listed on an auction forum, where bids may be placed by that may amount to or exceed the short sale offer. In many variations, the reserve price for the short sale item as listed on the auction forum may be equivalent to the value of the short sale offer. Typically, the reserve price is the minimum value a seller and/or mortgage holder may accept in order for a transaction to take place. Furthermore, a highest bid or a final bid report may be generated and submitted to a respective lienholder as a data point for the short sale item. The final bid report may be used by the lienholder in its independent process for approving a short sale.

The auction forum includes an auction interface (e.g., an auction webpage) including one or more auctions, or links to one or more auctions, where sellers, items, and prospective buyers can be identified and the corresponding auctions can be analyzed. At any given time, a short sale offer can be submitted to a lienholder for a short sale item. The short sale offer can be made through a bid over the auction forum, or alternatively, the short sale offer can be made to a lienholder linked to the auction forum. The short sale offer may then trigger an auction for the short sale item over the auction forum where a reserve price for the item is equated with the short sale offer. During the auction period for the short sale item, the auction forum, or an entity associated with the auction forum, may place automatic bids, or perform “robo-bidding” functions, up to the reserve price to progress the auction. A report generator can be coupled to the auction forum to analyze bids for the short sale item. Additionally, the report generator can be configured to extend the auction period for the short sale item when, for example, a bid is submitted that exceeds the short sale offer (i.e., the reserve price). Further still, the report generator can be configured to generate a bid report that can then be submitted to the lienholder. The bid report may include bidding activity for the short sale item that may or may not include robo-bidding activity. Alternatively, the bid report may simply list the current or final highest bid.

Auction Verification System

FIG. 1A illustrates an example of a system 100 for determining a lienholder and making a short sale offer. With reference to FIG. 1A, a user network 187 includes a user interface 188, in which prospective buyers may submit queries to browse listed items and submit bids 189 for those items. Using the interface 188, a prospective buyer may wish to submit a short sale bid 189 to the lienholder 199 of an interested property. A lienholder determination component 190 may be included to ascertain property IDs 194 and corresponding lien information 195. Further, an offer submission interface 191 can be included where prospective buyers may ultimately submit bids 189 (e.g., short sale offers) for listed items. The bids 189 can be submitted through the offer submission interface 191 directly to the lienholder 199.

The user interface 188 can be linked to the lienholder determination component 190, and may be configured to submit property and lienholder queries to the lienholder determination component 190. As an addition or alternative, the user interface 188 can be linked to the offer submission interface 191. Prospective buyers using the user interface 188 may submit bids 189 for one or more listed items which may then be directed to the offer submission interface 191 in order to ultimately be submitted to the lienholders 199 of the listed items.

The lienholder determination component 190 can be linked to a property listing database 193, which stores records and information of the listed properties. The records can include a property ID 194 for the interested property and/or lien information 195 for the interested property. The lienholder determination component 190 may acquire or otherwise compile data relating to the interested property and submit a lien query 197 for the interested property to a lienholder database 192. The lien query 197 may include an account number 196 associated with the interested property. The lienholder database 192 can store and/or organize data for various lienholders, such as account numbers 196 for listed properties, associated lien queries 197, and/or lienholder contact information 198 for those properties.

The offer submission interface 191 can be configured to draw or otherwise acquire or trigger the acquisition of lienholder contact information 198 associated with the interested property from the lienholder database 192. Further, the offer submission interface 191 can receive the bid from the prospective buyer for the interested property, correlate the interested property with the lien contact 198 from the lienholder database 192, and ultimately submit the short sale bid 189 to the lienholder 199 of the interested property.

FIG. 1B illustrates an example of a system 150 for triggering an auction for a short sale item and subsequently generating a bid report 162 to be submitted to a lienholder 170 of a short sale item. With further reference to FIG. 1B, the prospective buyer's short sale offer 166 for an item can be directed through a lienholder interface 140. The lienholder interface 140 can be linked to the auction forum, and can be configured to trigger a short sale auction 156 upon receiving the offer 166.

In variations, the short sale offer 166 can ultimately trigger the auction forum to list the item for auction. Auction forum users can then place bids on the item until an auction period for the auction ends. Once the auction period ends, the auction forum can generate and submit the bid report 162 to the lienholder 170, who can use the bid report to determine whether or not to accept the short sale offer 166.

In other variations, the item may already be listed on the lienholder interface 140, and a subsequent bid can be placed by a prospective buyer 166 that amounts to less than the full amount of liens on the property. In such variations, the subsequent bid can be considered a short sale offer 166, and the auction 156 can continue to progress until the auction period ultimately ends. The auction forum, or a component therein, can then issue the bid report 162 including bidding activity data to the lienholder 170 accordingly.

In further variations, the short sale offer 166 can cause the schedule 151 connected to an auction forum, to list the item on the auction forum interface 155. The item may be any commercial item in which a debt may be secured against its value, such as a parcel of real estate. The resulting short sale auction 156 can take place in which the reserve price 153 of the property can be equated with the value of the short sale offer 166. Short sale auction data 158 comprising information related to the short sale auction 156 (e.g., current bids, highest bid, bidder information, the listed property, etc.), can be communicated to the report generator 160, which can process the auction data 158. After the short sale auction 156 ends, the report generator 130 can then generate the bid report 162 that can be submitted to the lienholder 170 of the short sale item (e.g., a bank).

Additionally, the auction extension component 165 can be included to extend the auction period for the listed property in the occurrence of any number of events, such as when a bid is placed. Such events can also include an expiration of the auction period where the highest bid does not amount to the reserve price 153, or a request to extend the period by, for example, the owner of the short sale item, the lienholder, and/or the auction forum itself. The auction extension component 165 may be coupled to the report generator 160, or may be configured to analyze the short sale auction data 158 communicated from the auction forum.

Further, the auction forum can perform robo-bidding to progress the auction. Such robo-bidding can amount up to the reserve price set for the auction item. The auction extension component 165 can be further configured to extend the auction period when a robo-bid is placed. Alternatively, the auction extension component 165 can be configured to only extend the auction period when a bid is placed by a bidder or when a bid is placed that exceeds the reserve price of the short sale item. The final bid report 162 generated by the report generator 160 can exclude all data associated with robo-bidding. Thus, the final bid report 162 can be submitted to a lienholder of the item (e.g., a bank), where the final bid report 162 illustrates bidding activity associated solely with actual bidders. Finally, the lienholder can use the final bid report 162 as a reference as to whether or not to accept the short sale offer 166 for the item.

FIG. 1C illustrates an example of a system 150 for triggering an auction for a short sale item and subsequently generating a bid report to be submitted to a lienholder. A system 150, such as shown by an example of FIG. 1C, can be implemented in connection with an example system 100 as shown by FIG. 1A, and/or with an online auction forum comprised of one or more auctions 122 for any type of commercial item, such as, for example, real property items, (e.g., homes, real-estate notes, commercial property), motor vehicles (e.g., automobiles, motorcycles, boats), consumer electronics, collectibles, or clothing. Furthermore, system 150 can be implemented in connection with any lienholder 120, such as a bank, receiving short sale offers 116 for short sale items. A communication link between the lienholder 120 and auction forum can be configured to trigger an auction upon the event of a short sale offer 116 by a prospective buyer. Upon triggering the auction for the listed short sale item (hereinafter “short sale auction” 126), the short sale item is listed on an auction forum interface 125, thereby allowing other prospective buyers (hereinafter “bidders”) to place bids on the short sale item. A reserve price 123 for the listed short sale item may be equivalent to the initial short sale offer 116 by the prospective buyer. Additionally, the auction forum, or a representative thereof, can perform robo-bidding, so long as the robo-bids do not exceed the reserve price 123 of the listed short sale item.

Outside the system 150, the short sale item may be placed for sale in the open market, such as described by examples of system 100 and shown by examples of FIG. 1A. The short sale item can be any commercial item in which a debt may be secured against its value, such as a parcel of real estate. Such a debt may be in the form of a lien secured by a lienholder 120. The lienholder 120 may be any entity having an ability issue a loan secured on an item, such as a creditor or bank. The owner of the item may be an individual, or any entity capable of purchasing property or other commercial items. At any given time, the prospective buyer can place a short sale offer 116 to the owner or the lienholder 120 of the short sale item. The short sale offer can be any amount up to a current value of the short sale item. The prospective buyer can also be an individual, or any entity capable of purchasing property or other commercial items.

In an example of FIG. 1C, system 100 includes functionality that can be implemented by processes, logical components, and/or modules. In an example of FIG. 1C, system 100 includes an auction forum interface 125 associated with an auction forum, where auction users, or bidders, can participate in one or more auctions 122. The auction forum can be an auction service where bidders can place bids for items being auctioned. Alternatively, the auction forum may be an implementation of the auction service whereby bidders interact with one or more auctions 122 listed on the auction forum interface 125. The communication link between the system 100 and the lienholder entity 120 may be established. For example, the communication link may be configured to communicate to a schedule 121 operating in connection with the auction forum interface 125. In variations, once a short sale offer 116 is submitted to a lienholder 120 by a prospective buyer 116 for a short sale item, the communication link can transmit a signal to the schedule 121. Additionally or as an alternative, the communication link can be configured to communicate between the lienholder 120 and report generator 130 operating in connection with the auction forum interface 125. Furthermore, a final bid report 132 (as described below) can be generated and submitted to the lienholder 120 via the communication link.

The schedule 121 is operatively coupled with the auction forum interface 125, and can be configured to detect or otherwise receive communications (e.g., a trigger signal) relating to the short sale offer 116. Upon receiving such a trigger signal, the schedule 121 communicates to the auction forum that a short sale offer 116 has been placed for a particular short sale item. The short sale item can then be listed on the auction forum interface 125, and thus a short sale auction 126 can take place over a predetermined auction period for the item. The reserve price 123 for the short sale auction 126 can be set as equivalent to the initial short sale offer 116. Alternatively, the reserve price 123 may be set at any value relating to a valuation of the short sale item. The short sale item can be listed automatically upon receiving a trigger signal. Alternatively, the short sale auction 126 may be triggered through an internal selection process implemented by the auction forum.

The short sale auction 126 can take place as any typical auction 122 listed on the auction forum interface 125. In this fashion, bidders place bids for the short sale item wherein the highest bid results in a final transaction between the highest bidder and the owner of the short sale item. Alternatively, the short sale auction 126 can be configured in the form of a foreclosure auction, wherein the lienholder 120 sets the reserve price 123 as the remaining balance on the lien. Still further, the short sale auction 126 may be automatically or otherwise arranged so that the reserve price 123 may be set at the value of the short sale offer 116, and a highest resulting bid or a generated bid report 132 at the end of the auction period may be used as data by the lienholder 120. In these and related examples, the data may be treated by the lienholder 120 regarding whether or not to approve the short sale of the item or accept the initial short sale offer.

During the short sale auction 126, the auction forum can place bids on behalf of the owner of the short sale item so long as these bids do not exceed the reserve price 123. Additionally or as an alternative, bids can be placed on behalf of the lienholder 120 or the auction forum itself. This robo-bidding process can be performed by the auction forum in order to progress the auction, and/or ultimately complete a transaction wherein the final transaction price is equal to or greater than the reserve price 123. Alternatively, the robo-bidding process can be implemented to progress the auction in order to ultimately generate the final bid report 132 which can be submitted to the lienholder 120. The lienholder 120 may use this bid report 132 as a reference as to whether or not it will approve the short sale for the listed item.

In variations, a report generator 130 can be configured to process short sale auction data 128 relating to the short sale auction 126. The short sale auction data 128 can include current bids, a highest bid, the reserve price 123, bidder IDs, owner ID, lienholder 120 ID, short sale offer 116 value, prospective buyer ID, and/or information relating to the short sale item. Additionally, the report generator 130 can be configured to receive or acquire auction records 129 from an auction database 133. These auction records 129 can include various data related to the auction forum (e.g., transaction histories, auction item types, seller and buyer profiles, etc.). The report generator 130 can utilize such auction records 129 combined with short sale auction data 128 in order to generate the final bid report 132 for the lienholder.

In variations, the report generator 130 is configured to generate the bid report 132, which can illustrate bidding activity during the short sale auction 126. The bid report 132 can be generated using the auction records 129 from the auction database 133 and/or short sale auction data 128 from the short sale auction 126. In certain variations, the report generator 132 can stream the bidding activity of a current short sale auction 126 to the lienholder 120. However, additionally or as an alternative, the final bid report 132 may be generated after the short sale auction 126 has ended, or any time during the auction period. In similar variations, the bid report can include all short sale auction data 128 communicated from the auction forum. Similarly, the bid report 132 can contain information relating solely to bidding activity during the auction period. In still other variations, the final bid report 132 is comprised of bidding activity excluding the robo-bids placed by the auction forum. Alternatively, the bid report 132 can simply contain information relating to the highest bid made by a bidder during the auction period. As described above, the final bid report 132 can be treated by the lienholder 120 as a data point regarding whether or not to approve the short sale of the short sale item. In other words, the lienholder 120 may use the bid report 132 as a reference for whether or not to accept the short sale offer 116 from the prospective buyer or approve of the short sale of the item.

Auction data included in the final bid report 132 can include information (e.g., profile information) about prospective buyers participating in the auction. Furthermore, the final bid report 132 can include time stamps corresponding to each bid, the amount of each bid, location information corresponding to the bidders' respective locations, and information about the short sale item, including a current estimated value. The final bid report 132 can also include details regarding the auction itself, including the auction period, how many extensions were implemented, the period of each extension, the reasons for each extension, information relating to robo-bidding activity, etc.

The system 100 can include an auction extension component 135 configured to extend the auction period for a short sale auction 126 when a given event takes place. For example, the auction extension component 135 can extend the auction period whenever a bid has been placed for the short sale item. In variations, in order to extend the auction period, the bid can be placed within a predetermined time prior to expiration of the auction period. Additionally or as an alternative, the auction extension component 135 can extend the auction period when a bid is placed that equates to or exceeds the reserve price 123 of the short sale item. Additionally or as an alternative, the auction extension component 135 is linked to the report generator 130 which can simply trigger the auction extension component 135 to extend the auction period upon a given event. In similar variations, the report generator 130 is configured to perform all functions as described of the auction extension component 135. In such variations, the report generator 130 and the auction extension component 135 can be utilized as a single component performing any and/or all functions described.

In other examples, the auction extension component 135 is coupled to the auction forum itself. In these and related examples, the auction extension component 135 is configured to detect or otherwise receive communications from the auction forum. The auction extension component 135 can process the communications and make a determination of whether or not to extend the auction period for the short sale auction 126. For example, during the short sale auction 126 a bid can be placed by a bidder and the auction forum can communicate the event to the auction extension component 135. The auction extension component 135 can process the communication and extend the auction period accordingly. In other examples, numerous bids, confidential maximum bids, actual offers, etc., can be placed for the short sale item by a plurality of bidders. The auction forum can communicate such short sale auction data 128 to the auction extension component 135, which can process the data 128 and extend the auction period upon identifying one or more events. For example, the auction extension component 135 can be configured to extend the short sale auction 126 in the event that a placed bid equates to or exceeds the reserve price 123. Alternatively, the auction extension component 135 can be configured to extend the short sale auction 126 when bids are placed by bidders that do not amount to the reserve price 123. Accordingly, the auction extension component 135 can process the short sale auction data 128 and extend the short sale auction 126 accordingly.

In further examples, the system 100, such as described by examples of FIG. 1C, is implemented in connection with any lienholder entity 120, such as a bank, and any short sale item, such as a parcel of real estate. In such scenarios, the item of real estate can have a valuation that is less than the full amount of liens encumbered upon the property. Furthermore, the owner of the property might be unable to afford to repay the liens' full amount. Thus, the property can be placed for sale on the market where prospective buyers can submit short sale offers 116 to buy the property. Such short sale offers can also amount to less than the full amount of liens. The short sale offer 116 can be submitted directly to the bank or other lienholder, via a communication link through the auction forum.

In variations, the short sale offer 116 ultimately triggers the auction forum to list the property for auction. Bidders can then bid on the property until the auction period ultimately ends. As discussed above, this auction period may be extended for any number of reasons, such as in response to the occurrence of an event such as a placed bid that exceeds (or fails to meet) the reserve price. Once the auction period ends, the auction forum can generate and submit the bid report 132 to the bank, which may use the bid report to determine whether or not to accept the short sale offer 116.

In related scenarios, the property may already be listed on the auction forum, and a subsequent bid may be placed by a prospective buyer that amounts to less than the full amount of liens on the property. In these scenarios, the subsequent bid can be considered a short sale offer 116 by the auction forum, and the auction 126 can continue to progress until the auction period ultimately ends. The auction forum, or a component therein, may then generate and issue a bid report 132, as described above, to the bank or other lienholder accordingly as if a short sale auction for the property had occurred.

In further variations, the short sale offer 116 can cause the schedule 121 connected to the auction forum to list the property on the auction forum interface 125. The resulting short sale auction 126 can take place in which the reserve price 123 of the property is equated with the value of the short sale offer 116. Short sale auction data 128 comprising information related to the short sale auction 126 (e.g., current bids, highest bid, bidder information, the listed property, etc.), can then be communicated to the report generator 130, which can process the auction data 128. After the short sale auction 126 ends, the report generator 130 generates the bid report 132 and submits it to the lienholder.

Additionally, the auction extension component 135 can be included to extend the auction period for the listed property when a bid is placed. The auction extension component 135 can be coupled to the report generator 130, or can be configured to analyze the short sale auction data 128 communicated from the auction forum. Accordingly, the auction extension component 135 can continuously monitor the short sale auction during the auction period, and can be preconfigured to extend the auction period triggered upon any number of predetermined events or conditions. For example, when the auction within a predetermined time prior to completion of the auction period (e.g., 5 minutes, 5 hours, or 5 days prior to completion of the auction period), the auction extension component 135 can be configured to extend the auction by a predetermined period (e.g., another day). In such examples, one or more bids submitted during this clearance period amounting to less than the reserve price can indicate that the auction is gaining momentum and that the auction period should be extended in order to accommodate the prospective buyers and allow the bidding to surpass the reserve price in order to facilitate a final transaction.

Further, the auction forum can perform robo-bidding to progress the auction up to the reserve price. The auction extension component 135 can further be configured to extend the auction period when a robo-bid is placed. Alternatively, the auction extension component 135 is configured to only extend the auction period when a bid is placed by a bidder, or when a bid is placed that exceeds the reserve price. The final bid report 132 generated by the report generator 130 may exclude all data associated with robo-bidding. Thus, the final bid report 132 may be submitted to the bank illustrating bidding activity associated solely with bidders. As a result, the bank can use the final bid report 132 as a reference as to whether or not to accept the short sale offer 116 for the property.

Auction Verification Methodology

FIG. 2 illustrates an example method of triggering a short sale auction and generating a bid report. Methods such as described in FIG. 2 can be implemented using, for example, a system such as described in FIG. 1C. Accordingly, reference may be made to elements of system 150, as shown in an example of FIG. 1C, for the purpose of illustrating suitable components or elements for performing a step or sub step being described.

With reference to FIG. 2, the short sale item can be placed on the market, in which case the short sale offer 116 by the prospective buyer can be detected (200). The short sale offer 116 can be detected by the schedule 121 via the communication link between the auction forum and the lienholder 120, in which case the lienholder 120 receives the initial offer 116. Alternatively, the short sale offer 116 is placed by an internal component, such as a lienholder interface 140 as shown by an example of FIG. 1B.

Upon detection of the short sale offer 116, the system 100 can then trigger a short sale auction 126 for the item (202). The short sale item can be listed on the auction forum interface 125, and bids for the item can then be placed by auction forum users. The reserve price 123 for the short sale item can be equated with the value of the short sale offer 116. In addition, the auction forum can place bids on behalf of the owner of the short sale item in order to progress the short sale auction 126. Further, the auction forum can place bids on behalf of the lienholder 120 in order to progress the auction 126. Throughout the short sale auction 126, auction data 128 can be generated and communicated to the report generator 130.

In variations, the report generator 130 is configured to analyze the short sale auction data 128 for the short sale auction 126 (204). The short sale auction data 128 can include current bids, a highest bid, the reserve price 123, bidder IDs, owner ID, lienholder 120 ID, short sale offer 116 value, prospective buyer ID, and/or information relating to the short sale item. The report generator 130 can further be configured to process the short sale auction data 128 and ultimately generate a bid report 132 (206). Additionally or as an alternative, the report generator 130 can continuously generate the bid report 132 (206) throughout the auction period. The bid report 132 may comprise bidding activity during the auction period. The bidding activity included in the bid report 132 may or may not include bidding activity performed by the auction forum. As described above, final bid reports 132 can be generated which include bidding activity from actual bidders participating the short sale auction 126 and exclude bidding activity performed by the auction forum (i.e., robo-bidding).

Additionally or as an alternative, the auction extension component 135 is included to extend the auction period upon a given event (208). The auction extension component 135 is configured to directly process the short sale auction data 128, and accordingly extend the auction period (208) when, for example, a bid is submitted by a bidder. Alternatively, the auction extension component 135 can be triggered to extend the auction period by another system component, such as the report generator 130 or the auction forum itself. Other examples of events that can cause the auction extension component 135 to extend the auction period include; bids submitted by the auction forum (i.e., robo-bids), bids submitted that equate to or exceed the reserve price 123, a set time prior to the end of the auction period, and/or the end of the auction period itself.

When the short sale auction 126 is completed, the report generator 130 can generate and submit the bid report 132 to the lienholder 120 (210). In variations, the report generator 130 can submit the bid report anytime during the short sale auction 126. For example, the report generator 130 can stream bidding activity to the lienholder 120, in which case the stream may be considered a “live” bid report 132. Such a live bid report can include all of the above information discussed with respect to the final bid report 132. Upon receiving the bid report 132, the lienholder 120 can use the report 132 as a data point regarding whether or not to approve the short sale of the item. In other words, the lienholder 120 can use the bid report 132 as a reference for whether or not to accept the short sale offer 116 from the prospective buyer.

Computer System

FIG. 3 is a block diagram that illustrates a computer system upon which examples described herein may be implemented. For example, in the context of FIG. 1C, system 150 may be implemented using one or more servers such as described by FIG. 3.

Referring to FIG. 3, computer system 300 includes processor 302, memory 304 (including non-transitory memory), storage device 306, and communication interface 308. Computer system 300 includes at least one processor 302 for processing information. Computer system 300 also includes the main memory 304, such as a random access memory (RAM) or other dynamic storage device, for storing information and instructions to be executed by processor 302. Main memory 304 also may be used for storing temporary variables or other intermediate information during execution of instructions to be executed by processor 302. Computer system 300 may also include a read only memory (ROM) or other static storage device for storing static information and instructions for processor 302. The storage device 306, such as a magnetic disk or optical disk, is provided for storing information and instructions. The communication interface 308 may enable the computer system 300 to communicate with one or more networks through use of the network link 310 (wireless or wireline). The communication interface 308 may communicate with one or more system components, such as the auction forum, the report generator 130, the auction database 133, and/or the auction extension component 135, by way of, for example, Ethernet link, the Internet, or other cloud network.

Examples described herein are related to the use of computer system 300 for implementing the techniques described herein. In variations, those techniques are performed by computer system 300 in response to processor 302 executing one or more sequences of one or more instructions contained in main memory 304. Such instructions may be read into main memory 304 from another machine-readable medium, such as storage device 306. Execution of the sequences of instructions contained in main memory 304 causes processor 302 to perform the process steps described herein. In further variations, hard-wired circuitry may be used in place of or in combination with software instructions to implement examples described herein. Thus, examples described are not limited to any specific combination of hardware circuitry and software.

Short Sale Creation System

FIG. 4 illustrates an example system, generally designated 400, that creates short sale process flows and manages the flows for real estate assets. The assets may be offered for sale through brokered, seller-managed, or auction-driven marketing channels. According to some examples, the system 400 can be implemented through software that operates on various computing platforms, such as a general-purpose computer, a web-based server, and/or mobile computing device. System 400 can also be implemented through other computer systems in alternative architectures (e.g., peer-to-peer networks, etc.).

In one example, the system 400 includes a seller interface 402 that may be accessed by a seller computing device 404 through a network connection 406. A request module 408 solicits information from the seller in the form of prompts. The prompts may be configured in a manner that facilitates grouping similar content together such that certain short-sale process specific forms may be generated. The information may include basic asset data 410 such as the asset square footage, number of bedrooms, number of baths, the types of appliances in the kitchen, aspects of the front and back yards, and so forth. Much of this information is used to create a listing of the short sale opportunity.

Further referring to FIG. 4, relevant data for use in assembling a package for a lender may also be requested. This may include a data prompt for relevant Housing and Urban Development Form 1 (HUD-1) information 412. In a similar manner, the request module 408 may request information sufficient to provide the basis for a financial statement 414. A financial statement is often required by a lender in order to authorize a short sale. Additional information may be requested or prompted that forms the basis for a hardship letter 416. Tax information 418 may also be requested, and electronic copies of tax returns included in the information request. Income information 420 in the form of W2s and bank statements may also be requested for uploading into the system. In variations, a Comparative Market Analysis (CMA) 422 may be requested. All or part of the collected information and documents may be stored in a system database 431.

Once the request module 408 is finished with the prompted data collection from the asset seller, the information may be aggregated and processed by a listing generator 424 and a workflow manager 426. The listing generator compiles the asset information into a format suitable for online viewing by prospective buyers. Multiple listings may be tabulated in a listing information module 428, where they may be sorted and selectively viewed by buyers. In variations, the listing may highlight certain points-of-interest, such as individual rooms, the kitchen, and so forth.

Further referring to FIG. 4, the workflow manager 426 organizes the HUD, hardship and financial data into various forms and letters into a comprehensive package that may be electronically submitted to the lending institution that holds the note on the real estate asset. The package provides the information needed by the lending institution in order to evaluate the short sale request, and provides the basis for bank authorization to proceed with the short sale. Communication with the lending institution may be made via a bank interface 430 that communicates with, for example, a loss mitigation department 432 of an institution via network 434.

Prospective asset buyers looking to discover and possibly make an offer on a short sale opportunity may access the system 400 via a personal computing device 436 over a network 438 that communicates with an offer interface 440. The prospective buyer may peruse listing information from the listing information module 428, and if interested enough to purchase the asset, submit an offer through an offer management module 442.

With continued reference to FIG. 4, the offer management module 442 receives offers from prospective buyers, and relays the offer information to the workflow manager 426. The offer may be communicated to the seller 404 through coordination of the workflow manager 426 or through direct connection via the offer manager 442. The workflow manager monitors the offer with the seller, and also coordinates any counteroffers from the seller to the buyer. Once an agreement on terms has been reached, the workflow manager puts together a Contract for the Sale of Real Property that includes the buyer, seller, and lending institution as parties. The Agreement may then be forwarded to the parties for signature, and the signature status monitored.

In order for the sale to enter a “closing” process, the lending institution must agree to the terms of the deal. Often, the price offered is less than the market value of the property. In some variations, the risk posed by the lending institution in accepting a certain price may be reduced by obtaining data evidencing market value of the property. This may be either in the form of a Broker Price Opinion (BPO), or other market data. In similar variations, price data may be gleaned by carrying out an auction for the property via an auction module 450.

The auction module 450 interacts with the workflow manager 426 and communicates with an auction interface 452. Bidders 454 may access the auction module 450 via a network 456. Generally, as more fully explained below, a highest price bid on the property will be communicated to the lending institution as a data point regarding the market value for the property. Variations of the auction module 450 and associated methods are described more fully below.

Short Sale Creation and Management Methodology

FIG. 5 illustrates an example method for creating a short sale listing, and assembling a short sale document package for submission to the lending institution. A method such as described by examples of FIG. 5 can be implemented using, for example, components described with respect to FIG. 4. Accordingly, references made to elements of FIG. 4 are for purposes of illustrating a suitable element or component for performing a step or sub-step being described.

In FIG. 5, a seller is prompted to enter a variety of inputs, where in one variation, the inputs are indicative of points-of-interest that are associated with the asset, at 502. The prompts enable the asset seller to provide basic factual data and optional image and/or audio data regarding the real property asset in a manner suitable for an online listing. A geocode specifying, for example, the GPS coordinates of the asset may also be provided.

Once the asset information is entered by the asset seller, basic HUD information may be requested, at 504, in order to automatically fill out a HUD-1 form. This form is the standard settlement statement often used in real estate transactions.

One of the underlying requirements for most short sale transactions involves the seller providing financial hardship to the lienholder (lending institution). The request module 408 requests, through prompts, reasons underlying the financial hardship associated with the seller, at 506. These reasons may later be assembled by the workflow manager into a hardship letter for submission to the lender.

Additional financial information may also be requested and collected, such as copies of tax returns, at 508, copies of W2 income statements, at 510, copies of payroll stubs, at 512, and copies of bank statements, at 514. The documents are typically scanned and uploaded by the seller and stored in the system database 431.

A further item often required by lending institutions before they will authorize a short sale is a Comparative Market Analysis (CMA). This is generally a broker price opinion that is not as thorough as an appraisal, but provides some evidence of market value for the property. The request module prompts for a CMA, at 516. In some variations, as more fully explained below, this prompt may trigger an auction process involving the auction module 450 such as that described above.

As the information is collected, the listing generator 424 aggregates the property-specific information into an online listing, at 518. This may involve organizing various content into one or more viewable pages for visual review by a prospective buyer. The listing information may also be used as the workflow manager 426 compiles the financial information on the seller for submission to the lienholder, at 520. When the package is complete, the workflow manager may selectively interface with the lienholder, at 522. As prospective buyers become involved in the short sale process, the workflow manager 426 selectively interfaces with the prospective buyers, at 524.

FIG. 6 illustrates an example of a short sale workflow method that involves interfacing with various parties involved in the short sale. To begin the lienholder authorization process, the workflow manager 426 can submit a short sale request package to the lending institution or leinholder, at 602. The package generally includes a compilation of documents and information for review by a loss mitigation agent at the institution. Networked communication with the loss mitigation agent allows for tracking, at 604, and periodic electronic status updates for all parties involved.

Following posting of the online short sale listing, the offer interface 440 may be enabled to accept information requests from prospective buyers, and/or offers to buy the short sale property. The offer manager 442 monitors and detects when offers are submitted, at 606, and coordinates interfacing the buyer 436 with the seller 404, at 608. The buyer and seller may negotiate terms of the deal between them, and when terms are agreed, a standard contract may be generated by the workflow manager 426. At this point, the workflow manager 426 may coordinate communications between the seller, buyer and lienholder, at 610.

As part of the initial short sale request package, information regarding market value of the property may have been submitted. A short sale process often takes several months, and market value may change during that time. Consequently, leinholders often desire up-to-date valuations of the property asset. One way to carry this out is to have a subsequent formal Broker Price Opinion (BPO) prepared in order to judge whether the offered price for the asset is reasonable. Another way to handle the market value issue is to carry out an auction, similar to that described above. Either step may be carried out by the system 400, at 612.

The workflow manager 426 also carries out regular reminders for certain actions to be handled by the various parties, at 614. Automatically managing reminders in this way helps avoid unnecessary delays in the process flow. Further, the workflow manager 426 carries out regular status updates for the parties to the short sale, at 616.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the invention is not limited to those precise examples. As such, many modifications and variations will be apparent to practitioners skilled in this art. Accordingly, it is intended that the scope of the invention be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude the inventor from claiming rights to such combinations.

What is claimed is:

1. A computer implemented method for managing a short sale transaction, the method being performed by one or more processors and comprising:
monitoring an auction forum including one or more auctions for items of property;
detecting a short sale offer for a selected property listed on the auction forum;
in response to detecting the short sale offer, acquiring lien information for the selected property, the lien information including an account identifier for a lienholder account associated with a lienholder of the selected property;
accessing the lienholder account to determine contact information for the lienholder of the selected property, and
based on the contact information, submitting the short sale offer to the lienholder of the selected property.

2. The method of claim 1, further comprising automatically determining, from the short sale offer, a property identifier for the selected property, wherein the property identifier is used to correlate the selected property with the lien information in a property listing database.

3. The method of claim 1, wherein the lienholder account is stored in a lienholder database separate from the property listing database.

4. The method of claim 3, wherein determining the contact information is performed by sending a query to the lienholder database.

5. The method of claim 3, further comprising dynamically managing the property listing database and the lienholder database to reflect current lienholder information for the items of property.

6. The method of claim 1, further comprising generating and providing an auction forum interface integrated in a user network for the auction forum, the auction forum interface to enable users to browse property listings and submit bids for any of the items of property, wherein the short sale offer is submitted over the auction forum interface.

7. The method of claim 6, wherein the lienholder account is unique to the auction forum, and wherein the short sale offer is automatically submitted to the lienholder of the selected property via the auction forum interface.

8. A system for managing a short sale transaction comprising:
a property listing database to store lien information corresponding to one or more items of property listed on an auction forum:
a lienholder database to store lienholder accounts including contact information for lienholders corresponding to the one or more items of property; and
one or more processors to:
monitor the auction forum, the auction forum including one or more auctions for the items of property;
detect a short sale offer for a selected property listed on the auction forum;
in response to detecting the short sale offer, acquire lien information from the property listing database for the selected property, the lien information including an account identifier for a lienholder account associated with a lienholder of the selected property;
accessing the lienholder account in the lienholder database to determine contact information for the lienholder of the selected property, and
based on the contact information, submitting the short sale offer to the lienholder of the selected property.

9. The system of claim 8, wherein the one or more processors determine, from the short sale offer, a property identifier for the selected property, wherein the property identifier is used to correlate the selected property with the lien information in the property listing database.

10. The system of claim 8, wherein determining the contact information is performed by sending a query to the lienholder database.

11. The system of claim 8, wherein the one or more processors dynamically manage the property listing database and the lienholder database to reflect current lienholder information for the items of property.

12. The system of claim 8, wherein the one or more processors generate and provide an auction forum interface integrated in a user network for the auction forum, the auction forum interface to enable users to browse property listings and submit bids for any of the items of property, wherein the short sale offer is submitted over the auction forum interface.

13. The system of claim 12, wherein the lienholder account is unique to the auction forum, and wherein the short sale offer is automatically submitted to the lienholder of the selected property via the auction forum interface.

14. A non-transitory computer readable medium storing instructions that, when executed by one or more processors, cause the one or more processors to perform steps comprising:
monitoring an auction forum including one or more auctions for items of property;
detecting a short sale offer for a selected property listed on the auction forum;
in response to detecting the short sale offer, acquiring lien information for the selected property, the lien information including an account identifier for a lienholder account associated with a lienholder of the selected property;
accessing the lienholder account to determine contact information for the lienholder of the selected property, and
based on the contact information, submitting the short sale offer to the lienholder of the selected property.

15. The non-transitory computer readable medium of claim 14, wherein the instructions, when executed, cause the one or more processors to perform steps further comprising:
automatically determining, from the short sale offer, a property identifier for the selected property, wherein the property identifier is used to correlate the selected property with the lien information in a property listing database.

16. The non-transitory computer readable medium of claim 15, wherein the lienholder account is stored in a lienholder database separate from the property listing database.

17. The non-transitory computer readable medium of claim 16, wherein determining the contact information is performed by sending a query to the lienholder database.

18. The non-transitory computer readable medium of claim 16, wherein the instructions, when executed, cause the one or more processors to perform steps further comprising:
dynamically managing the property listing database and the lienholder database to reflect current lienholder information for the items of property.

19. The non-transitory computer readable medium of claim 14, wherein the instructions, when executed, cause the one or more processors to perform steps further comprising:
generating and providing an auction forum interface integrated in a user network for the auction forum, the auction forum interface to enable users to browse property listings and submit bids for any of the items of property, wherein the short sale offer is submitted over the auction forum interface.

20. The non-transitory computer readable medium of claim 19, wherein the lienholder account is unique to the auction forum, and wherein the short sale offer is automatically submitted to the lienholder of the selected property via the auction forum interface.
